(19) United States
(12) Patent Application Publication
(10) Pub. No.: US 2020/0092720 A1
(43) Pub. Date: Mar. 19, 2020

(54) EXTENSIBLE AUTHENTICATION PROTOCOL (EAP) IMPLEMENTATION IN NEW RADIO (NR)

(71) Applicant: QUALCOMM Incorporated, San Diego, CA (US)

(72) Inventors: Tom CHIN, San Diego, CA (US); Juan ZHANG, San Diego, CA (US); Ajith Tom PAYYAPPILLY, San Diego, CA (US)

(21) Appl. No.: 16/548,381

(22) Filed: Aug. 22, 2019

Related U.S. Application Data
(60) Provisional application No. 62/730,863, filed on Sep. 13, 2018.

(51) Int. Cl. H04W 12/06; H04W 12/04; H04W 60/02

(52) U.S. Cl. CPC H04W 12/06; H04W 60/02; H04W 12/04

(57) ABSTRACT

A new radio (NR) user equipment (UE) registration procedure that may be executed by a UE and a network is disclosed, resulting in a UE registration that may be more efficient than existing UE registration procedures. For example, the UE registration procedure may utilize messaging between an extensible authentication protocol (EAP) component and a non-access stratum (NAS) component to abort the registration procedure when a non-recoverable EAP failure occurs, or suspend or re-start a NAS registration timer when a recoverable EAP failure occurs.

### CROSS REFERENCE TO RELATED APPLICATION(S)

This application claims the benefit of U.S. Provisional Application Ser. No. 62/730,863, entitled “EXTENSIBLE AUTHENTICATION PROTOCOL (EAP) IMPLEMENTATION IN NEW RADIO (NR)” and filed on Sep. 13, 2018, which is expressly incorporated by reference herein in its entirety.

### BACKGROUND

### Technical Field

The present disclosure relates generally to communication systems, and more particularly, to communications between a user equipment (UE) and a wireless communication network.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5GNR technology. These improvements may also be applicable to other multi-access technologies and the telecommunication standards that employ these technologies.

For example, for NR communications technology and beyond, current UE registration procedures may not provide efficient operation. Thus, improvements in wireless communication operations may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, methods, computer-readable mediums, and apparatuses are provided.

In an aspect, the present disclosure includes a method of wireless communications at a user equipment (UE). The method may include initiating a security procedure for registering the UE at a first network, where the UE implements an extensible authentication protocol (EAP) component and a non-access stratum (NAS) component. The method may further include starting a NAS registration timer at the NAS component in response to initiating the security procedure, where an expiration of the NAS registration timer is configured to cause the NAS component to abort the security procedure. The method may further include determining an EAP failure in the security procedure. The method may further include determining whether the EAP failure is a recoverable type failure that is recoverable by retrying at least a portion of the security procedure or a not-recoverable type failure that is not recoverable by retrying any portion of the security procedure. The method may further include aborting the security procedure in response to the EAP failure being the not-recoverable type failure. The method may further include suspending or re-starting the NAS registration timer in response to the EAP failure being the recoverable type failure.

Moreover, the present disclosure also includes a UE having a memory in communication with at least one processor configured to initiate a security procedure for registering the UE at a first network, wherein the UE implements an extensible authentication protocol (EAP) component and a non-access stratum (NAS) component. The at least one processor is further configured to start a NAS registration timer at the NAS component in response to initiating the security procedure, wherein an expiration of the NAS registration timer is configured to cause the NAS component to abort the security procedure. The at least one processor is further configured to determine an EAP failure in the security procedure. The at least one processor is further configured to determine whether the EAP failure is a recoverable type failure that is recoverable by retrying at least a portion of the security procedure or a not-recoverable type failure that is not recoverable by retrying any portion of the security procedure. The at least one processor is further configured to abort the security procedure in response to the EAP failure being the not-recoverable type failure. The at least one processor is further configured to suspend or re-start the NAS registration timer in response to the EAP failure being the recoverable type failure.

Moreover, the present disclosure also includes a user equipment (UE) including means for initiating a security procedure for registering the UE at a first network, wherein the UE implements an extensible authentication protocol (EAP) component and a non-access stratum (NAS) component. The UE further includes means for starting a NAS registration timer at the NAS component in response to initiating the security procedure, wherein an expiration of the NAS registration timer is configured to cause the NAS component to abort the security procedure. The UE further includes means for determining an EAP failure in the security procedure. The UE further includes means for determining whether the EAP failure is a recoverable type failure that is recoverable by retrying at least a portion of the security procedure or a not-recoverable type failure that is not recoverable by retrying any portion of the security procedure. The UE further includes means for aborting the security procedure in response to the EAP failure being the not-recoverable type failure. The UE further includes means for suspending or re-starting the NAS registration timer in response to the EAP failure being the recoverable type failure.

Moreover, the present disclosure also includes a non-transitory computer-readable medium storing computer code executable by a processor of a user equipment (UE), wherein the computer code, when executed by the processor, causes the processor to initiate a security procedure for registering the UE at a first network, wherein the UE implements an extensible authentication protocol (EAP) component and a non-access stratum (NAS) component. The computer code, when executed by the processor, further causes the processor to start a NAS registration timer at the NAS component in response to initiating the security procedure, wherein an expiration of the NAS registration timer is configured to cause the NAS component to abort the security procedure. The computer code, when executed by the processor, further causes the processor to determine an EAP failure in the security procedure. The computer code, when executed by the processor, further causes the processor to determine whether the EAP failure is a recoverable type failure that is recoverable by retrying at least a portion of the security procedure or a not-recoverable type failure that is not recoverable by retrying any portion of the security procedure. The computer code, when executed by the processor, further causes the processor to abort the security procedure in response to the EAP failure being the not-recoverable type failure. The computer code, when executed by the processor, further causes the processor to suspend or re-start the NAS registration timer in response to the EAP failure being the recoverable type failure.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram of an example of a wireless communications system and an access network including at least one user equipment (UE) having an extensible authentication protocol (EAP) component and a non-access stratum (NAS) component configured according to this disclosure to perform UE registration procedures;

FIG. 2 is an example message sequence flow for UE registration, according to a first aspect of the disclosure;

FIG. 3 is an example message sequence flow for UE registration, according to a second aspect of the disclosure;

FIG. 4 is an example message sequence flow for UE registration, according to a third aspect of the disclosure;

FIG. 5 is an example message sequence flow for UE registration, according to a fourth aspect of the disclosure;

FIG. 6 is an example message sequence flow for UE registration, according to a fifth aspect of the disclosure;

FIG. 7 is a block diagram of a first example UE implementation, according to an aspect of the disclosure;

FIG. 8 is a block diagram of a second example UE implementation, according to an aspect of the disclosure;

FIG. 9 is a flow chart of a first example method for UE registration, according to aspects of the disclosure;

FIG. 10 is a flow chart of a second example method for UE registration, according to aspects of the disclosure;

FIG. 11 is a flow chart of a third example method for UE registration, according to aspects of the disclosure;

FIG. 12 is a block diagram of example components of the UE of FIG. 1, according to aspects of the disclosure;

FIG. 13 is a block diagram of example components of the base station of FIG. 1, according to aspects of the disclosure; and

FIG. 14 is a diagram of example components of a base station and a UE in an access network, according to aspects of the disclosure

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

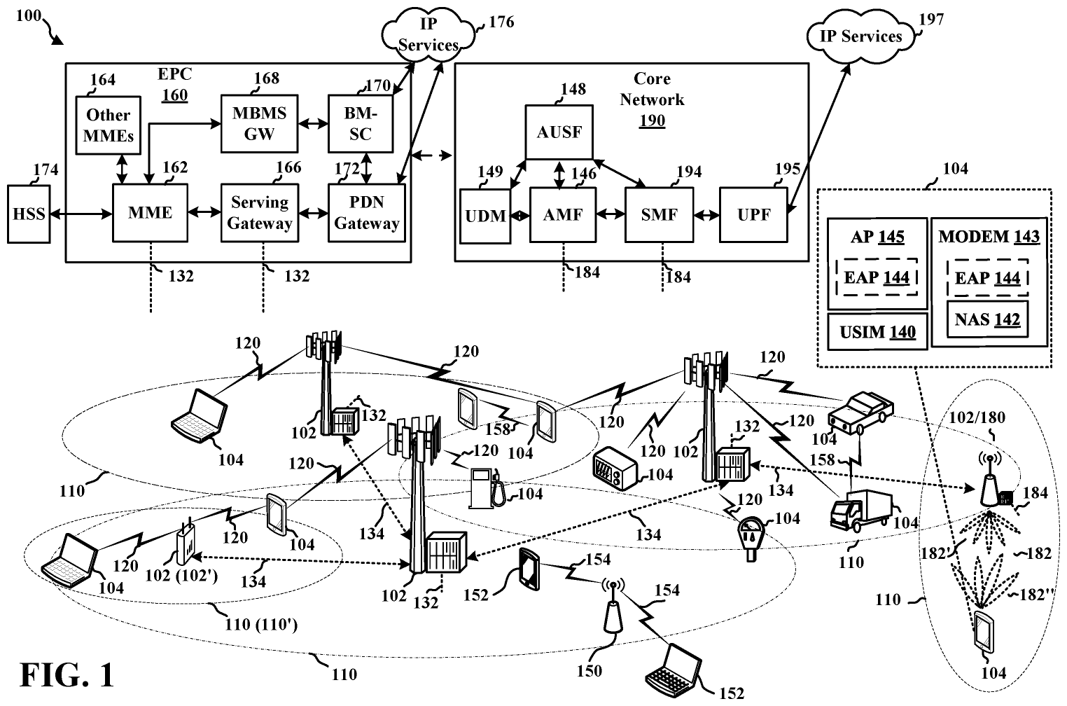

Some present aspects relate to improved user equipment (UE) registration procedures in new radio (NR) networks, using messaging between an extensible authentication protocol (EAP) component and a non-access stratum (NAS) component implemented in a UE. Additional features of the present aspects are described in more detail below with respect to FIGS. 1-14.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Referring to FIG. 1, in accordance with various aspects of the present disclosure, an example wireless communication system and access network 100 (also referred to as a wireless wide area network (WWAN)) includes base stations 102, UEs 104, an Evolved Packet Core (EPC) 160, and another core network 190 (e.g., a 5G Core (5GC)). The UE 104 includes a universal subscriber identity module (USIM) 140, a NAS component 142, and an EAP component 144, that together with an access and mobility management function (AMF) component 146 and an authentication server function (AUSF) component 148 in the 5GC 190 and a user data management (UDM) component 149 in the access network 100 perform UE registration procedures for registering the UE 104 at the access network 100. In an aspect, the NAS component 142 and the EAP component 144 are implemented within a modem 143 of the UE 104. In another aspect, the NAS component 142 is implemented within the modem 143 of the UE 104, while the EAP component 144 is implemented within an applications processor (AP) 145 of the UE 104. Further details of the present aspects are described below.

The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 and/or the backhaul links 132 and/or the backhaul links 184 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs (not shown), an Authentication Server Function (AUSF) 148, a Session Management Function (SMF) 194, and a User Plane Function (UPF) 195. The AMF component 146 may be in communication with a Unified Data Management (UDM) 149 that uses data such as subscription data, authentication data, etc. The AMF component 146 is the control node that processes the signaling between the UEs 104 and the core network 190. Generally, the AMF component 146 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services. The AUSF component 148 supports authentication for 3GPP access and untrusted non-3GPP access as specified in 3GPP TS 33.501. Further details of additional functions of the 5GC 190 are provided, for example, in 3GPP TS 23.501.

The base station 102 may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Aspects of the present disclosure provide enhancements to EAP security procedures for registering a UE at a wireless communications network. Some aspects are applicable to 5G standalone (SA) mode (e.g., 5G that is not supported by existing 4G), or any other future technology that requires EAP method for third generation authentication and key agreement (EAP-AKA, as described, for example, in internet engineering task force (IETF) request for comments (RFC) 4187) or improved EAP method for third generation authentication and key agreement (EAP-AKA′, as described, for example, in IETF RFC 5448) over 3GPP 5G NAS signaling.

Generally, NAS provides protocols for communicating messages between the UE 104 and the MME 162. The protocols and procedures for NAS are specified in 3GPP standards, for example, in 3GPP technical specification (TS) 24.501. However, the standards-based protocols and procedures for NAS assume AKA authentication (without EAP) during UE registration. For 5G, however, because of the network architecture (the NAS component 142 terminating at the AMF component 146 and the EAP component 144 terminating at the AUSF component 148), EAP-AKA (or EAP-AKA′) is run over NAS (not just AKA or AKA′ over NAS).

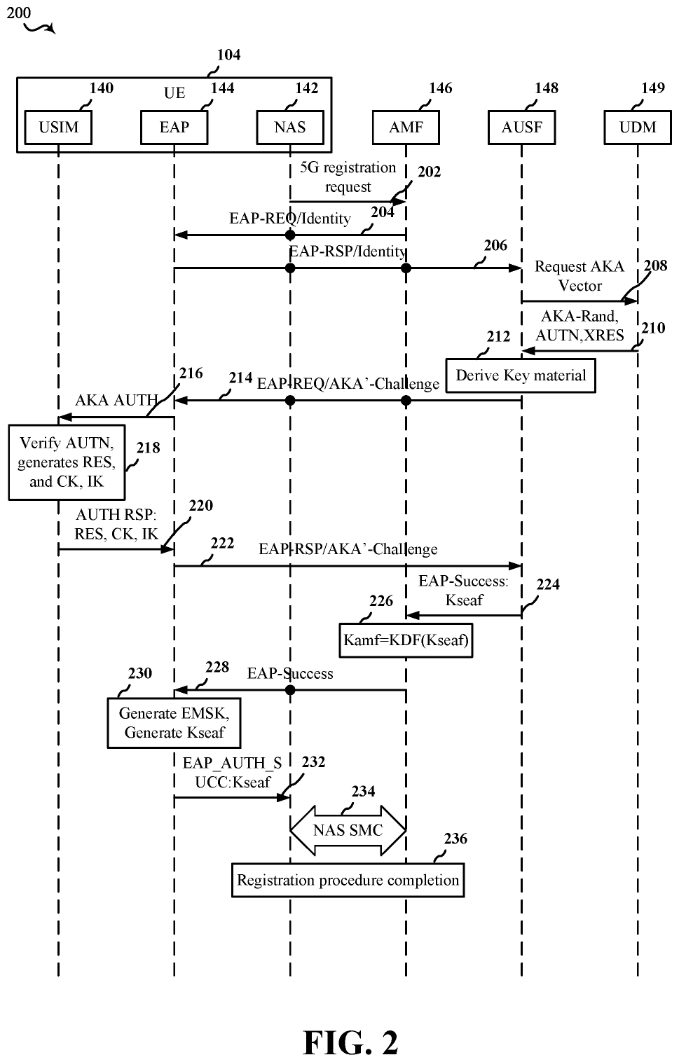

Referring to FIGS. 2-6, respectively, example message sequence flows 200, 300, 400, 500, and 600 for UE registration to a 5G network by EAP-AKA/AKA′ authentication are provided, according to aspects of the present disclosure. In one aspect, for example, in the access network 100 in FIG. 1, each one of the message sequence flows 200, 300, 400, 500, and 600 may be executed between the USIM 140, the NAS component 142, and the EAP component 144 of the UE 104, and the AMF component 146, the AUSF component 148, and the UDM component 149 of the EPC 160.

Referring first to FIG. 2, in an aspect, for example, message sequence flow 200 corresponds to successful UE registration at a wireless communication network. At 202 the UE registration procedure starts with the NAS component 142 in the UE 104 sending a 5G registration request to the AMF component 146. At 204 the AMF component 146 responds with an EAP-REQ/Identity message requesting the identity of the UE 104, and the NAS component 142 passes the EAP-REQ/Identity message to the EAP component 144. At 206 the EAP component 144 sends the UE identity in an EAP-RSP/Identity message to the NAS component 142, which passes the message to the AMF component 146, which passes the message to the AUSF component 148. At 208 the AUSF component 148 requests an AKA vector from the UDM component 149. At 210 the UDM component 149 responds to the AUSF component 148 with a generated random number ‘AKA-RAND, an authentication token ‘AUTN’, and an expected response ‘XRES’. At 212 the AUSF component 148 derives key material and sends an EAP message with an AKA′ challenge request EAP-REQ/AKA′-Challenge to the AMF component 146, which passes the message to the NAS component 142, which passes the message to the EAP component 144. At 216 the EAP component 144 sends a message to the USIM 140 for AKA authentication.

At 218 the USIM 140 verifies the authentication token ‘AUTN’ and generates a response ‘RES’, an integrity key ‘IK’, and a ciphering key ‘CK’. At 220 the USIM 140 sends an authentication response message AUTH RSP to the EAP component 144 with the ‘RES’, ‘CK’, and ‘IK’. At 222 the EAP component 144 sends an EAP message with an AKA′ challenge response EAP-RSP/AKA′-Challenge to the AUSF component 148. At 224 the AUSF component 148 sends an EAP-Success message to the AMF component 146 including a security anchor function (SEAF) anchor key Kseaf. At 226 the AMF component 146 uses a key derivation function (KDF) to generate an AMF key Kamf based on the Kseaf. At 228 the AMF component 146 sends an EAP success message EAP-Success to the NAS component 142, which passes the message to the EAP component 144. At 230 the EAP component 144 generates an extended master session key (EMSK) and the Kseaf. At 232 the EAP component 144 sends an EAP authentication success message EAP-AUTH-SUCC to the NAS component 142 with the Kseaf. At 234 the NAS component 142 and the AMF component 146 exchange NAS security mode commands (SMC). At 236 the registration procedure is successfully completed.

Some aspects of the present disclosure provide enhancement in EAP security procedures. The enhancements may: (1) lessen the chances of registration failures due to UE prematurely aborting the procedures; and (2) minimize delay in completing the NAS procedures when the UE needs to fall back and connect with a different network. Some aspects implement interactions and notifications between EAP (or entities managing EAP) and NAS in order to achieve the aforementioned enhancements as described below.

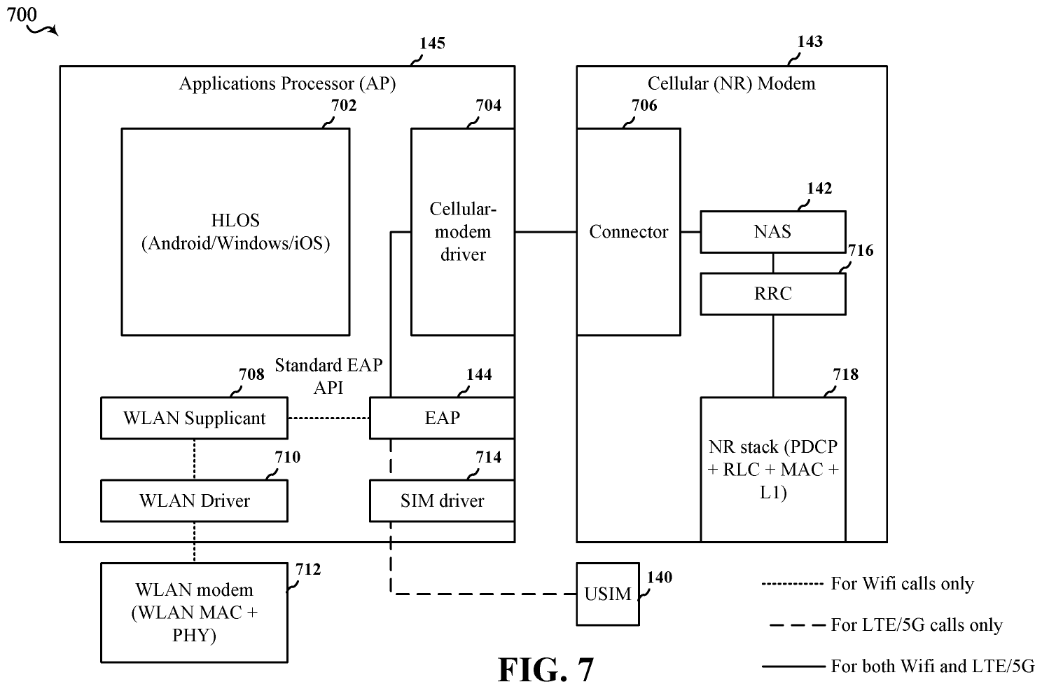

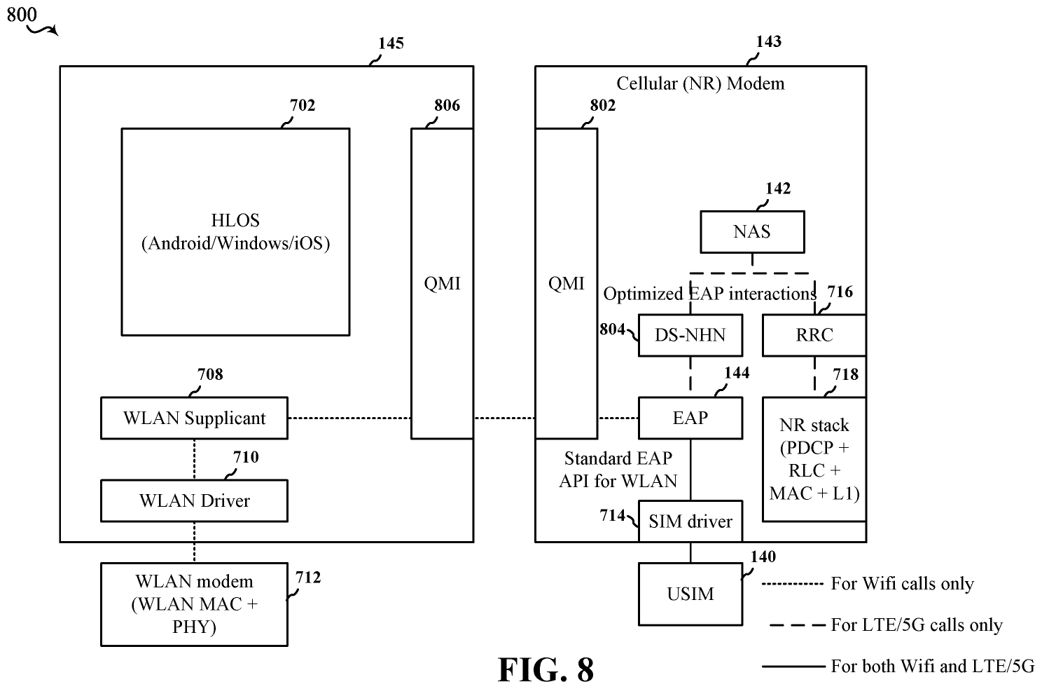

EAP is a standards-based authentication framework defined, for example, by IETF RFC 3748. In some aspects, EAP is not used in cellular 3GPP deployments, and EAP software is usually provided as a library by WiFi chipset vendors, by third parties that provide WiFi supplicant software, or by high level operating systems (HLOSs) to manage WiFi. Such EAP implementations have a standard application programming interface (API). However, some aspects provide chipsets that implement both EAP and NAS within a cellular modem (e.g., within Qualcomm CDMA Technologies (QCT) chipsets). Details of these example alternative aspects are provided herein with reference to FIGS. 7 and 8.

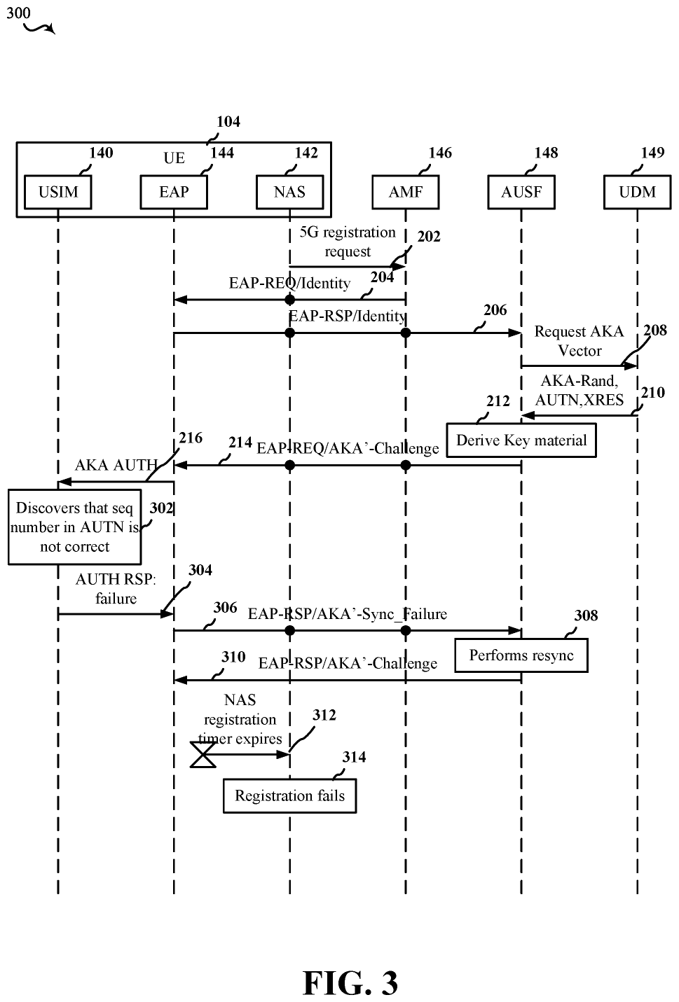

Referring now to FIG. 3, in an aspect, for example, the message sequence flow 300 corresponds to an EAP failure due to synchronization (also referred to herein as sync) failure, resulting in UE registration failure. The message sequence flow 300 is similar to the message sequence flow 200 up to 216 where the EAP component 144 sends a message to the USIM 140 for AKA authentication. However, in message sequence flow 300, at 302 the USIM 140 discovers that the sequence number in the authentication token AUTN is not correct. At 304 the USIM 140 sends an authentication response message AUTH RSP to the EAP component 144 indicating authentication failure. At 306 the EAP component 144 sends an AKA′ sync failure response message EAP-RSP/AKA′-Sync_Failure to the NAS component 142, which passes the message to the AMF component 146, which passes the message to the AUSF component 148. In an aspect, the sync failure may be corrected by retrying the sync. Therefore, at 308 the AUSF component 148 performs resynchronization (also referred to herein as resync). At 310 the AUSF component 148 sends another EAP message with an AKA′ challenge request EAP-REQ/AKA′-Challenge to the EAP component 144. However, before the resync is completed, at 312 a NAS registration timer at the NAS component 142 expires. Therefore, at 314 the registration fails. Further details of the timer and the registration failure are provided as follows.

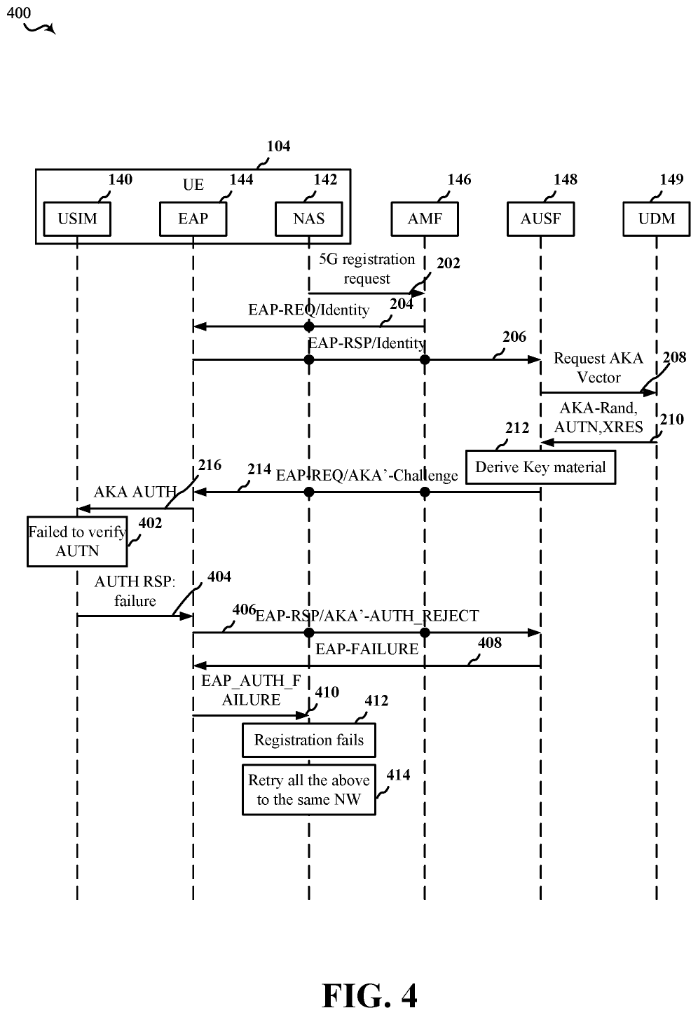

When the UE 104 starts 5G registration procedures, as part of the registration procedure, the NAS component 142 starts various timers (e.g., including one or more NAS registration timers) as specified in 3GPP standards, e.g., as specified in 3GPP TS 24.501. In an aspect, for example, the NAS component 142 may start one or more timers at 202. In some aspects, for example, the NAS timers may include timers T 3520 (applicable from step 408 to re-tried step 214 at the UE 104 in FIG. 4 described below), T3560 (applicable from step 214 to step 222 at the network in FIG. 2 described below), or any back-off timers.

In the example of FIG. 3, EAP-AKA/AKA′ fails at 302, but the failure is most likely not a permanent authentication failure (e.g., when the international mobile subscriber identity (IMSI) is invalid, when the IMSI is blocked, etc.), but a sync failure, and therefore further attempts from the network or the UE 104 may result in eventual success of authentication. However, if the EAP component 144 runs as in other wireless technologies (such as wireless local area network (WLAN)), the EAP component 144 will only notify a success/failure result to the NAS component 142 after all the retries (e.g., a configured number of retries) are over. In the meantime, one or more NAS timers may expire, causing the NAS component 142 to abort the registration procedures to the NR cell (e.g., the gNB 180 in the access network 100). If the UE 104 had waited additional time before aborting, the registration may have succeeded eventually.

Referring now to FIG. 4, in an aspect, for example, the example message sequence flow 400 corresponds to EAP failure due to the UE 104 failing to authenticate with the 5G network. The message sequence flow 400 is similar to the message sequence flows 200 and 300 up to 216 where the EAP component 144 sends a message to the USIM 140 for AKA authentication. However, in message sequence flow 400, at 402 the USIM 140 fails to verify the authentication token AUTN. At 404 the USIM 140 sends an authentication response message AUTH RSP to the EAP component 144 indicating authentication failure. At 406 the EAP component 144 sends an AKA′ authentication reject response message EAP-RSP/AKA′-AUTH_Reject to the NAS component 142, which passes the message to the AMF component 146, which passes the message to the AUSF component 148. At 408 the AUSF component 148 sends an EAP failure message EAP_FAILURE to the EAP component 144. At 410 the EAP component 144 sends an EAP authentication failure message EAP_AUTH_FAILURE to the NAS component 142. Therefore, at 412 the registration fails. However, despite the failure, at 414 the NAS component 142 retries the message sequence flow 400 for registering the UE 104 to the same network. Further details of the registration failure and the retrying are provided as follows.

In an aspect, during registration procedures of the UE 104 with a 5G NAS such as the NAS component 142, EAP-AKA/AKA′ procedures are performed for authentication over NAS signaling. If the EAP component 144 performs EAP-AKA/AKA′ authentication as in other wireless technologies (such as WLAN or enhanced high-rate packet data (eHRPD)) and the NAS component 142 performs NAS procedures as in 3GPP technologies (i.e., 5G systems), even after the EAP component 144 fails to authenticate the UE 104 in the network, the EAP component 144 and the NAS component 142 will wait for the UE 104 to complete UE procedures, and the NAS component 142 may retry registration multiple times (e.g., retry a subset of steps from 208 to 408 in FIG. 4). While the retries are being attempted, the user gets no service/connectivity. Only after the NAS procedures are over, the UE 104 may fall back to some other technology, e.g., LTE.

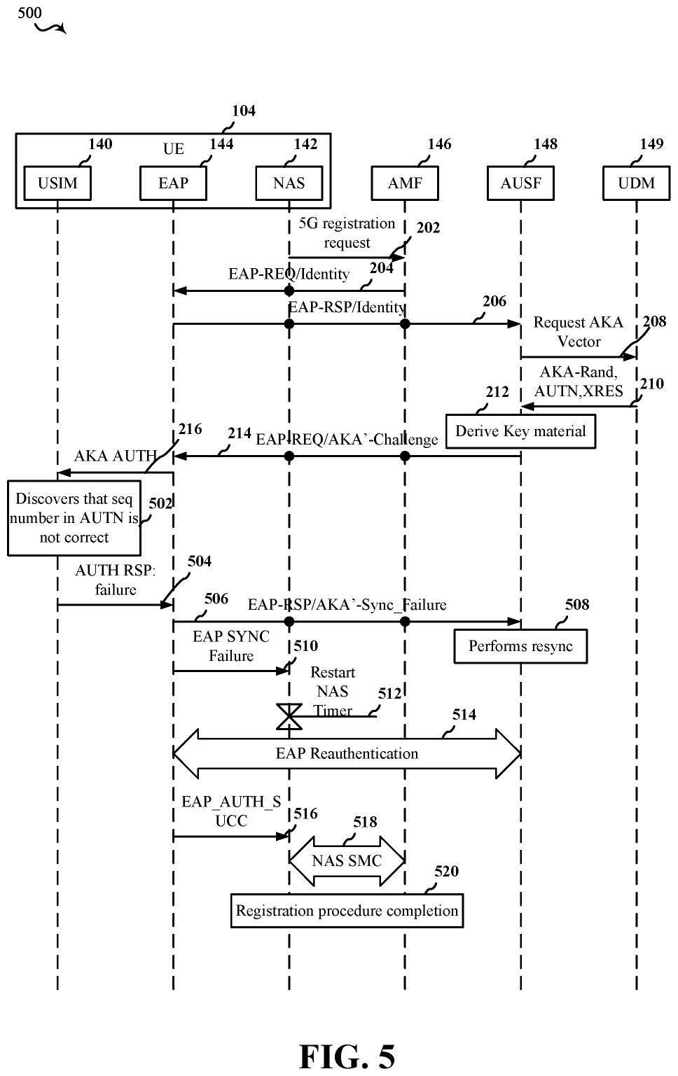

However, in some aspects, EAP and NAS layers are enhanced to exchange additional information for improved connectivity and registration. Referring now to FIG. 5, in an aspect, for example, the message sequence flow 500 avoids fatal registration failure in case of UE sync failure. The message sequence flow 500 is similar to the message sequence flows 200, 300, and 400 up to 216 where the EAP component 144 sends a message to the USIM 140 for AKA authentication. Further, as in 302 in the message sequence flow 300, at 502 in message sequence flow 500 the USIM 140 discovers that the sequence number in the authentication token AUTN is not correct. At 504 the USIM 140 sends an authentication response message AUTH RSP to the EAP component 144 indicating authentication failure. At 506 the EAP component 144 sends an AKA′ sync failure response message EAP-RSP/AKA′-Sync_Failure to the NAS component 142, which passes the message to the AMF component 146, which passes the message to the AUSF component 148. At 508 the AUSF component 148 performs resync. Further, at 510 the EAP component 144 also sends an EAP sync failure message to the NAS component 142. In response, at 512 the NAS component 142 suspends and/or restarts one or more NAS timers. At 514 the EAP component 144 and the AUSF component 148 perform EAP re-authentication. Upon successful EAP re-authentication, at 516 the EAP component 144 sends an EAP authentication success message EAP-AUTH-SUCC to the NAS component 142. At 518 the NAS component 142 and the AMF component 146 exchange NAS SMC, and at 520 the registration procedure is successfully completed. Further details related to suspending or restarting the timers are provided as follows.

In FIG. 5, when a sync failure is determined, the EAP component 144 determines that there is a possibility of eventual success if additional round-trip signaling messages are retried. That is, an EAP sync failure need not necessarily cause a fatal registration failure. Since such additional round-trip signaling messages may cause extra delay, the EAP component 144 provides a notification to the NAS component 142 to suspend or restart one or more NAS timers. As a result, the NAS component 142 does not prematurely abort the registration procedures, and the EAP component 144 is able to recover from the original sync failure by performing subsequent retries from the network to resync, and eventually the UE 104 may register to the 5G system.

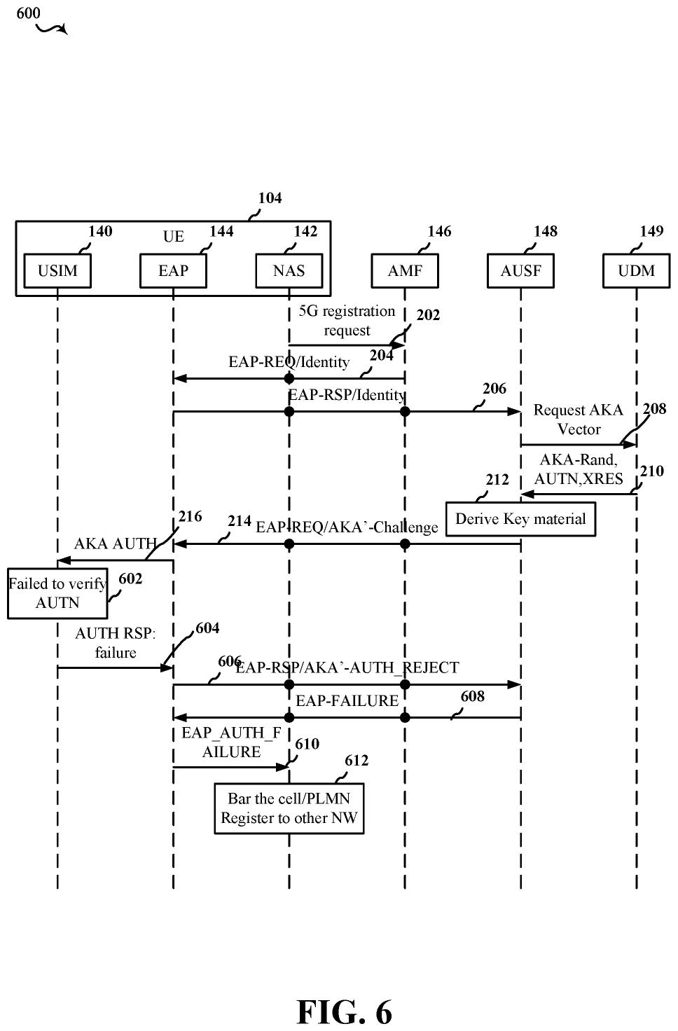

Referring now to FIG. 6, in an aspect, for example, the message sequence flow 600 aborts registration in case of a permanent network authentication failure. The message sequence flow 600 is similar to the message sequence flows 200, 300, 400, and 500 up to 216 where the EAP component 144 sends a message to the USIM 140 for AKA authentication. Further, as in 402 in the message sequence flow 400, at 602 the USIM 140 fails to verify the authentication token AUTN. At 604 the USIM 140 sends an authentication response message AUTH RSP to the EAP component 144 indicating authentication failure. At 606 the EAP component 144 sends an AKA′ authentication reject response message EAP-RSP/AKA′-AUTH_Reject to the NAS component 142, which passes the message to the AMF component 146, which passes the message to the AUSF component 148. At 608 the AUSF component 148 sends an EAP failure message EAP_FAILURE to the AMF component 146, which passes the message to the NAS component 142, which passes the message to the EAP component 144. At 610 the EAP component 144 sends an EAP authentication failure message EAP_AUTH_FAILURE to the NAS component 142. At 612 the registration fails and the NAS component 142 bars the current cell/PLMN from further registration retries, and instead tries to register the UE 104 with a different network. Further details of barring the current cell/PLMN from further registration retries and trying to register the UE 104 to a different network are provided as follows.

In the message sequence flow 600, when the EAP component 144 on the UE 104 has failed to authenticate the 5G network, there is no point in the NAS component 142 retrying registration to the same NR cell as the same result will keep repeating. Accordingly, at 610 the EAP component 144 provides a notification to the NAS component 142 to abort the registration procedures and bar the current NR cell or registration area from further registration attempts. The registration process is aborted at 612 since the UE 104 has a permanent network authentication failure, and the UE 104 may quickly move onto a different network. That is, instead of wasting time retrying registration to the same NR cell, the NAS component 142 gives up on the current cell and can falls back to a different network (e.g., LTE), thereby providing user data connectivity quicker compared to the message sequence flow 400 in FIG. 4.

Referring to FIGS. 7 and 8, respectively, a first example implementation 700 and a second example implementation 800 of a UE are provided, according to aspects of the present disclosure. Each one of the first example implementation 700 or the second example implementation 800 may be implemented by any UE disclosed herein, for example by the UE 104 in the access network 100 in FIG. 1. Each one of the first example implementation 700 or the second example implementation 800 is operable to register the UE 104 at a cellular network according to any procedures described herein, for example, the procedures described herein with reference to FIGS. 5 and 6.

Referring now to FIG. 7, in an aspect, for example, the first example implementation 700 corresponds to implementations where a mobile device maker does not buy the Wifi and/or 5G chip from QCT. The first software implementation 700 includes a cellular (NR) modem 143, an AP component 145, a WLAN modem 712 (providing WLAN MAC and physical layers), and a USIM 140. The cellular modem 143 includes a NAS component 142, a radio resource control (RRC) component 716, and an NR stack 718 (including packet data convergence protocol (PDCP), radio link control (RLC), media access control (MAC), physical layer (L1), etc.). The NAS component 142 communicates with the NR stack 718 via the RRC component 716. The AP component 145 includes an HLOS 702 (e.g., Android, Windows, iOS, etc.), a WLAN driver 710, a WLAN supplicant 708, a SIM driver 714, and a cellular modem driver 704. In an aspect, the AP component 145 further includes an EAP component 144 that implements an EAP layer that runs on the AP component 145 either as part of the HLOS 702 itself or separately as an EAP library. Either way, the EAP component 144 provides a standard EAP API and interface for communication with the WLAN supplicant 708 and for communication with the NAS component 142 in the cellular modem 143 through the cellular modem driver 704 and a connector 706 of the cellular modem 143 configured for interconnecting with the API. In an aspect, the USIM 140 and the EAP library 144 may communicate via the SIM driver 714. In an aspect, the WLAN modem 712 and the WLAN supplicant 708 communicate via the WLAN driver 710.

Referring now to FIG. 8, in an aspect, for example, the second example implementation 800 corresponds to a QCT chipset implementation. Similar to the first example implementation 700, the second example implementation 800 also includes the cellular (NR) modem 143 (including the NAS component 142, the RRC component 716, and the NR stack 718), the AP component 145 (including the HLOS 702, the WLAN driver 710, and the WLAN supplicant 708), and the USIM 140. However, unlike the first example implementation 700, in the second example implementation 800 the EAP layer runs on the cellular modem 143 and is implemented in the cellular modem 143 by an EAP component 144. The cellular modem 143 further includes the SIM driver 714 that provides communication between the EAP component 144 and the USIM 140.

In an aspect, for communication with the WLAN supplicant 708 in the AP component 145 through a cellular modem interface 802 and an AP interface 806 (each may be implemented by a Qualcomm modem interface (QMI)), the EAP component 144 provides the standard EAP API and interface, and the WLAN supplicant 708 can access the API (e.g., through the QMI) from the AP component 145. Moreover, for 5G use, the cellular modem 143 in the second example implementation 800 includes a Data Services Neutral Host Network (DS_NHN) component 804 that provides an additional layer above the EAP layer. The additional layer can be accessed by the 5G NAS component 142. In an aspect, the DS_NHN component 804 may provide the realizations of the interactions and optimizations described herein for improved UE registration, for example, as described herein with reference to FIGS. 5 and 6.

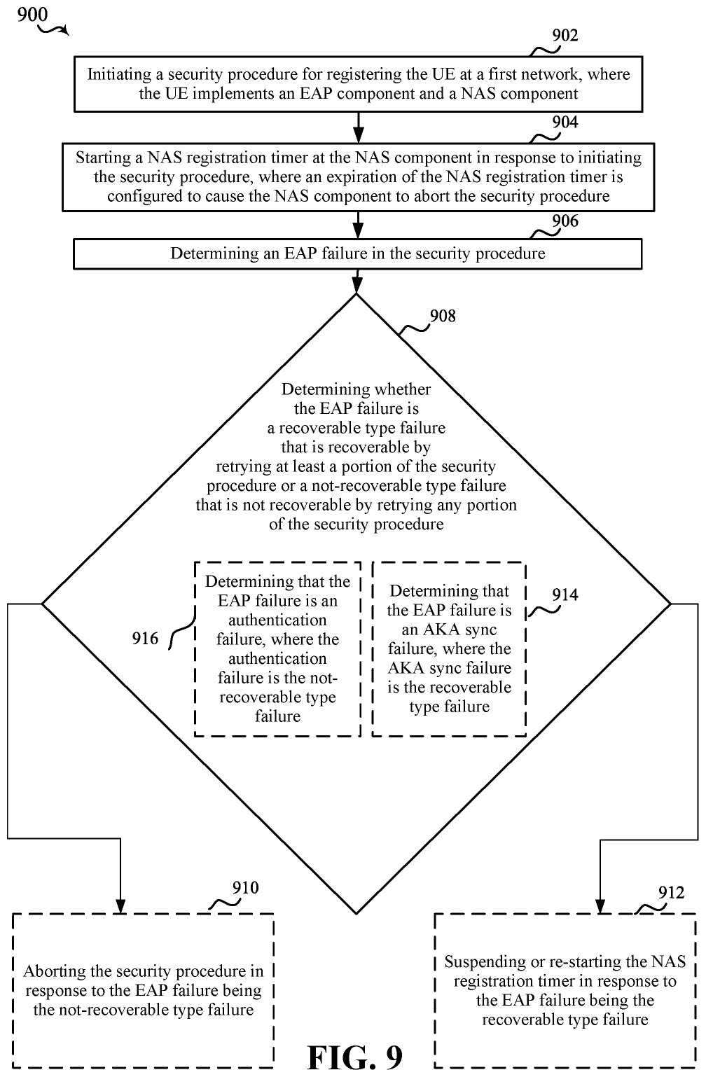

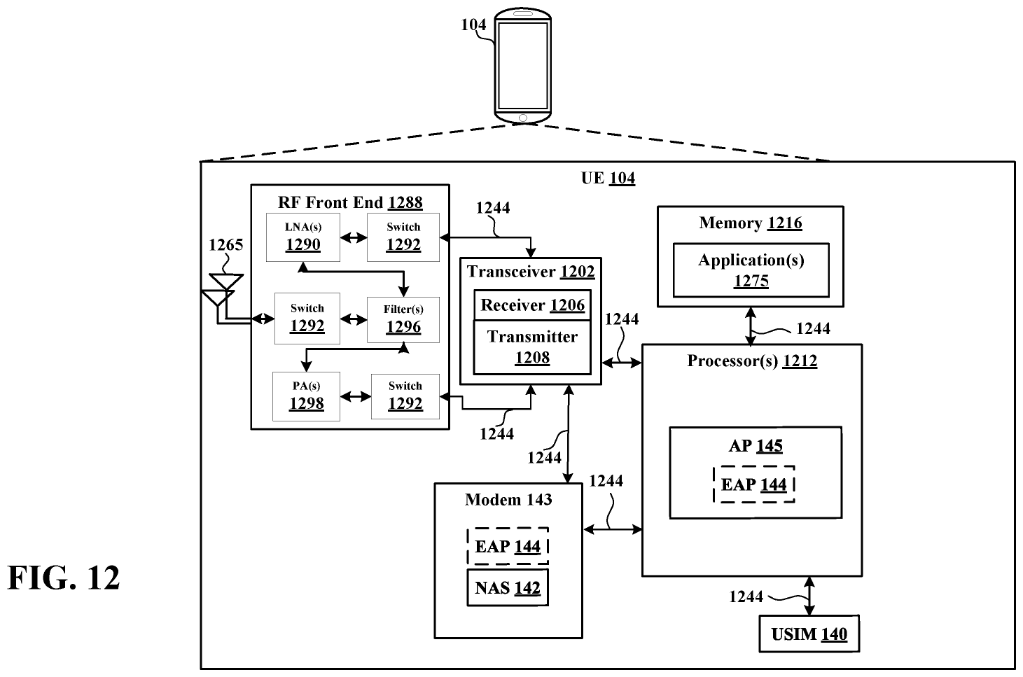

Referring to FIGS. 9-11, for example, methods 900, 1000, and 1100 of wireless communications at the UE 104 according to the above-described aspects to perform UE registration include one or more of the herein-defined actions. In an aspect, for example, each of the methods 900, 1000, and 1100 of wireless communications may be performed by a UE 104 which may include a memory 1216 (FIG. 12) and which may be the entire UE 104 or a component of the UE 104 such as the EAP component 144, the NAS component 142, the USIM 140, the modem 143, the AP component 145, the processor 1212 (FIG. 12), the transceiver 1202 (FIG. 12), etc.

Referring now to FIG. 9, in an aspect, for example, at 902 method 900 includes initiating a security procedure for registering the UE at a first network, where the UE implements an EAP component and a NAS component. For instance, in an aspect, the UE 104 may execute the NAS component 142 to initiate a security procedure for registering the UE 104 at access network 100, where the UE 104 implements an EAP layer by the EAP component 144 and a NAS layer by the NAS component 142, as described herein. For example, in an aspect, with reference to FIGS. 2-6, at 202 the NAS component 142 may send a 5G registration request to an AMF component 146 in an EPC 160 to initiate a registration procedure for registering the UE 104 at a network.

Accordingly, the UE 104, the EAP component 144, the NAS component 142, the USIM 140, the modem 143, the AP component 145, the processor 1212 (FIG. 12), and/or the transceiver 1202 (FIG. 12) may provide means for initiating a security procedure for registering the UE at a first network, where the UE implements an EAP component and a NAS component.

At 904, method 900 includes starting a NAS registration timer at the NAS component in response to initiating the security procedure, where an expiration of the NAS registration timer is configured to cause the NAS component to abort the security procedure. For example, in an aspect, the NAS component 142 may start a NAS registration timer at the NAS component in response to initiating the security procedure, where an expiration of the NAS registration timer is configured to cause the NAS component 142 to abort the security procedure. For example, in an aspect, the NAS component 142 may start one or more NAS registration timers after initiating the registration procedure for registering the UE 104 at a network.

Accordingly, the UE 104, the EAP component 144, the NAS component 142, the USIM 140, the modem 143, the AP component 145, the processor 1212 (FIG. 12), and/or the transceiver 1202 (FIG. 12) may provide means for starting a NAS registration timer at the NAS component in response to initiating the security procedure, where an expiration of the NAS registration timer is configured to cause the NAS component to abort the security procedure.

At 906, method 900 includes determining an EAP failure in the security procedure. For example, in an aspect, the USIM 140 may determine an EAP failure in the security procedure. For example, in an aspect, at 302 in FIG. 3 or at 502 in FIG. 5, the USIM 140 may discover that the sequence number in an authentication token AUTN received from the EAP component during the security procedure is incorrect. In some other aspects, for example, at 402 in FIG. 4 or at 602 in FIG. 6, the USIM 140 may fail to verify an authentication token AUTN received from the EAP component during the security procedure.

Accordingly, the UE 104, the EAP component 144, the NAS component 142, the USIM 140, the modem 143, the AP component 145, the processor 1212 (FIG. 12), and/or the transceiver 1202 (FIG. 12) may provide means for determining an EAP failure in the security procedure.

At 908, method 900 includes determining whether the EAP failure is a recoverable type failure that is recoverable by retrying at least a portion of the security procedure or a not-recoverable type failure that is not recoverable by retrying any portion of the security procedure. For example, in an aspect, the EAP component 144 may determine whether the EAP failure is a recoverable type failure that is recoverable by retrying at least a portion of the security procedure or a not-recoverable type failure that is not recoverable by retrying any portion of the security procedure. For example, in an aspect, after receiving the AUTH RSP: failure message at 504 in FIG. 5 or at 604 in FIG. 6, the EAP component 144 may look up a stored table (e.g., stored at the UE 104) to map the EAP failure to one of a recoverable type failure (e.g., a failure that may be recovered by retrying) or a not-recoverable type failure (e.g., a failure that cannot be recovered by retrying).

Accordingly, the UE 104, the EAP component 144, the NAS component 142, the USIM 140, the modem 143, the AP component 145, the processor 1212 (FIG. 12), and/or the transceiver 1202 (FIG. 12) may provide means for determining whether the EAP failure is a recoverable type failure that is recoverable by retrying at least a portion of the security procedure or a not-recoverable type failure that is not recoverable by retrying any portion of the security procedure.

At 910, method 900 includes aborting the security procedure in response to the EAP failure being the not-recoverable type failure. For example, in an aspect, the NAS component 142 may abort the security procedure in response to the EAP failure being the not-recoverable type failure. For example, in an aspect, at 610 in FIG. 6 the NAS component 142 may abort the security procedure in response to the EAP failure being an authentication failure that is not recoverable.

Accordingly, the UE 104, the EAP component 144, the NAS component 142, the USIM 140, the modem 143, the AP component 145, the processor 1212 (FIG. 12), and/or the transceiver 1202 (FIG. 12) may provide means for aborting the security procedure in response to the EAP failure being the not-recoverable type failure.

At 912, method 900 includes suspending or re-starting the NAS registration timer in response to the EAP failure being the recoverable type failure. For example, in an aspect, the NAS component 142 may suspend or re-start the NAS registration timer in response to the EAP failure being the recoverable type failure. For example, in an aspect, at 512 in FIG. 5 the NAS component 142 may suspend or re-start a NAS registration timer in response to the EAP failure being a sync failure which is recoverable by performing resync at 508 and performing re-authentication at 514.

Accordingly, the UE 104, the EAP component 144, the NAS component 142, the USIM 140, the modem 143, the AP component 145, the processor 1212 (FIG. 12), and/or the transceiver 1202 (FIG. 12) may provide means for suspending or re-starting the NAS registration timer in response to the EAP failure being the recoverable type failure.

In an aspect, for example, block 908 of method 900 may optionally further include block 914 or block 916. At 914, method 900 may further include determining that the EAP failure is an AKA sync failure, where the AKA sync failure is the recoverable type failure. For example, in an aspect, the EAP component 144 may determine that the EAP failure is an AKA sync failure, where the AKA sync failure is the recoverable type failure. For example, in an aspect, after receiving the AUTH RSP: failure message at 504 in FIG. 5 indicating an AKA sync failure, the EAP component 144 may look up a stored table (e.g., stored at the UE 104) to map the AKA sync failure to one a recoverable type failure (e.g., a failure that may be recovered by retrying).

Accordingly, the UE 104, the EAP component 144, the NAS component 142, the USIM 140, the modem 143, the AP component 145, the processor 1212 (FIG. 12), and/or the transceiver 1202 (FIG. 12) may provide means for determining that the EAP failure is an AKA sync failure, where the AKA sync failure is the recoverable type failure.

At 916, method 900 may further include determining that the EAP failure is an authentication failure, where the authentication failure is the not-recoverable type failure. For example, in an aspect, the EAP component 144 may determine that the EAP failure is an authentication failure, where the authentication failure is the not-recoverable type failure. For example, in an aspect, after receiving the AUTH RSP: failure message at 604 in FIG. 6 indicating an authentication failure, the EAP component 144 may look up a stored table (e.g., stored at the UE 104) to map the authentication failure to a not-recoverable type failure (e.g., a failure that cannot be recovered by retrying).

Accordingly, the UE 104, the EAP component 144, the NAS component 142, the USIM 140, the modem 143, the AP component 145, the processor 1212 (FIG. 12), and/or the transceiver 1202 (FIG. 12) may provide means for determining that the EAP failure is an authentication failure, where the authentication failure is the not-recoverable type failure.

In an aspect, for example, the first network may be a 5G network in a SA mode. For example, in an aspect, the first network is the access network 100 accessed via gNB 180, and is a 5G network in SA mode.

In an aspect, for example, the security procedure may be an EAP-AKA or an EAP-AKA′ authentication procedure over 3GPP 5G NAS signaling. For example, in an aspect, the security procedure for registering the UE 104 at the access network 100 is an EAP-AKA or an EAP-AKA′ authentication procedure over 3GPP 5G NAS signaling.

In an aspect, for example, the UE may include a cellular modem and an applications processor. For example, in an aspect, the UE 104 may include a cellular modem 143 and an AP component 145.

In an aspect, for example, the NAS component may be implemented in the cellular modem, and the EAP component may be implemented as an EAP library in the applications processor, where the EAP library and the NAS component communicate via at least one EAP API. For example, in an aspect, the NAS component 142 may be implemented in the cellular modem 143, and the EAP component 144 may be implemented as an EAP library in the AP component 145, where the EAP library and the NAS component 142 communicate via at least one EAP API, as described herein with reference to the example UE implementation 700 in FIG. 7.

In an aspect, for example, the NAS component and the EAP component may be implemented in the cellular modem, and the EAP component may implement an additional layer accessible by the NAS component, where the EAP component and the NAS component communicate via the additional layer. For example, in an aspect, a NAS component 142 and an EAP component 144 may be implemented in the cellular modem 143, and the EAP component 144 may implement an additional layer referred to as DS-NHN component 804 and accessible by the NAS component 142, and the EAP component 144 and the NAS component 142 communicate via the DS-NHN component 804, as described herein with reference to the second example software implementation 800 in FIG. 8.

In an aspect, for example, the NAS component may be configured according to 3GPP TS 24.501. For example, in an aspect, the NAS component 142 may be configured according to 3GPP TS 24.501 to implement a NAS layer at the UE 104.

In an aspect, for example, the EAP component may be configured according to IETF RFC 3748. For example, in an aspect, the EAP component 144 may be configured according to IETF RFC 3748 to implement an EAP layer at the UE 104.

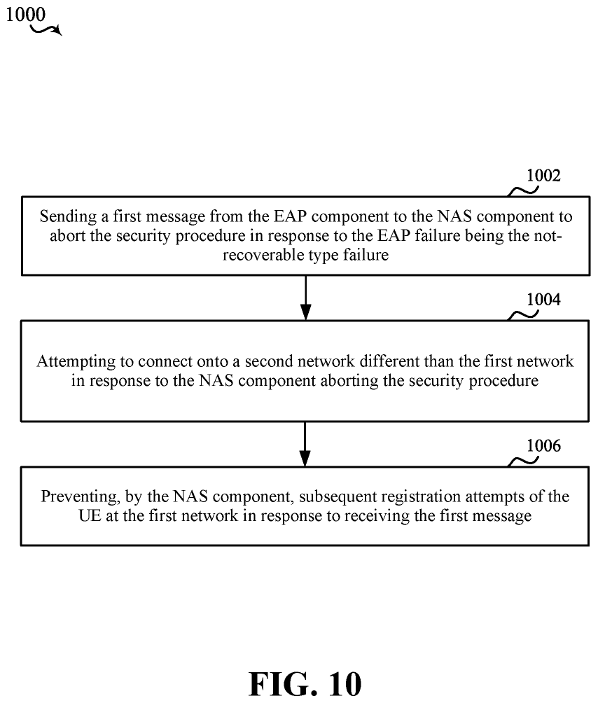

Referring now to FIG. 10, in an aspect, for example, method 900 may optionally include method 1000. Specifically, at 1002, method 1000 includes sending a first message from the EAP component to the NAS component to abort the security procedure in response to the EAP failure being the not-recoverable type failure. For example, in an aspect, the EAP component 144 may send a first message to the NAS component 142 to abort the security procedure in response to the EAP failure being the not-recoverable type failure. In an aspect, for example, aborting the security procedure is performed by the NAS component in response to receiving the first message. For example, in an aspect, the NAS component 142 may abort the security procedure in response to receiving the first message from the EAP component 144. For example, in an aspect, after receiving the authentication failure message EAP_AUTH_FAILURE at 610 in FIG. 6 indicating an authentication failure that is not recoverable by retrying, at 612 the NAS component 142 aborts the security procedure.

Accordingly, the UE 104, the EAP component 144, the NAS component 142, the USIM 140, the modem 143, the AP component 145, the processor 1212 (FIG. 12), and/or the transceiver 1202 (FIG. 12) may provide means for sending a first message from the EAP component to the NAS component to abort the security procedure in response to the EAP failure being the not-recoverable type failure.

At 1004, method 1000 includes attempting to connect onto a second network different than the first network in response to the NAS component aborting the security procedure. For example, in an aspect, the NAS component 142 may attempt to connect onto a second network different than the first network in response to the NAS component 142 aborting the security procedure. For example, in an aspect, after aborting the security procedure at 612 in FIG. 6, the NAS component 142 also attempts to connect to a different network.

Accordingly, the UE 104, the EAP component 144, the NAS component 142, the USIM 140, the modem 143, the AP component 145, the processor 1212 (FIG. 12), and/or the transceiver 1202 (FIG. 12) may provide means for attempting to connect onto a second network different than the first network in response to the NAS component aborting the security procedure.

At 1006, method 1000 includes preventing, by the NAS component, subsequent registration attempts of the UE at the first network in response to receiving the first message. For example, in an aspect, the NAS component 142 may prevent subsequent registration attempts of the UE 104 at the first network in response to receiving the first message from the EAP component 144. For example, in an aspect, after receiving the authentication failure message EAP_AUTH_FAILURE at 610 in FIG. 6 indicating an authentication failure that is not recoverable by retrying, at 612 the NAS component 142 may bar the current cell/PLMN from subsequent registration attempts by the UE 104.

Accordingly, the UE 104, the EAP component 144, the NAS component 142, the USIM 140, the modem 143, the AP component 145, the processor 1212 (FIG. 12), and/or the transceiver 1202 (FIG. 12) may provide means for preventing, by the NAS component, subsequent registration attempts of the UE at the first network in response to receiving the first message.

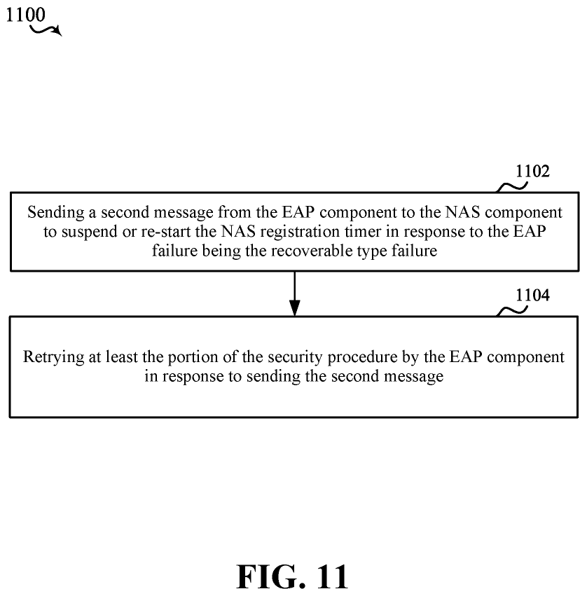

Referring now to FIG. 11, in an aspect, for example, method 900 may optionally be followed by method 1100. Specifically, at 1102, method 1100 includes sending a second message from the EAP component to the NAS component to suspend or re-start the NAS registration timer in response to the EAP failure being the recoverable type failure. For example, in an aspect, the EAP component 144 may send a second message to the NAS component 142 to suspend or re-start the NAS registration timer in response to the EAP failure being the recoverable type failure. In an aspect, for example, suspending or re-starting the NAS registration timer is performed by the NAS component in response to receiving the second message. For example, in an aspect, the NAS component 142 may suspend or re-start the NAS registration timer in response to receiving the second message from the EAP component 144. For example, in an aspect, after receiving an EAP SYNC Failure message from the EAP component 144 at 510 in FIG. 5 indicating an EAP sync failure which is recoverable by performing resync, the NAS component 142 suspends or re-starts a NAS registration timer.

Accordingly, the UE 104, the EAP component 144, the NAS component 142, the USIM 140, the modem 143, the AP component 145, the processor 1212 (FIG. 12), and/or the transceiver 1202 (FIG. 12) may provide means for sending a second message from the EAP component to the NAS component to suspend or re-start the NAS registration timer in response to the EAP failure being the recoverable type failure.

At 1104, method 1100 includes retrying at least the portion of the security procedure by the EAP component in response to sending the second message. For example, in an aspect, the EAP component may retry at least the portion of the security procedure by in response to sending the second message. For example, in an aspect, after sending an EAP SYNC Failure message to the NAS component 142 at 510 in FIG. 5 indicating an EAP sync failure which is recoverable by performing resync, at 506 the EAP component 144 may try resyncing by sending an EAP-RSP/AKA′-Sync_Failure message to the NAS component 142, which passes the message to the AMF component 146, which passes the message to the AUSF component 148 to perform resync at 508.

Accordingly, the UE 104, the EAP component 144, the NAS component 142, the USIM 140, the modem 143, the AP component 145, the processor 1212 (FIG. 12), and/or the transceiver 1202 (FIG. 12) may provide means for retrying at least the portion of the security procedure by the EAP component in response to sending the second message.

Referring to FIG. 12, one example of an implementation of UE 104 may include a variety of components, some of which have already been described above, but including components such as a USIM 140, one or more processors 1212, memory 1216, and transceiver 1202 in communication via one or more buses 1244, which may operate to enable one or more of the functions described herein related to registering the UE 104 in a network. Further, the USIM 140, the one or more processors 1212, the memory 1216, the transceiver 1202, the RF front end 1288, and one or more antennas 1265 may be configured to support voice and/or data calls (simultaneously or non-simultaneously) in one or more radio access technologies.

In an aspect, the one or more processors 1212 can include an AP component 145 that uses one or more processors as well as a modem 143 that uses one or more modem processors. The various functions related to the NAS component 142 may be included in the modem 143 and, in an aspect, can be executed by a single processor, while in other aspects, different ones of the functions may be executed by a combination of two or more different processors. Further, the various functions related to the EAP component 144 may be included either in the modem 143 or in the AP component 145 (e.g., as described herein with reference to FIGS. 7 and 8) and, in an aspect, can be executed by a single processor, while in other aspects, different ones of the functions may be executed by a combination of two or more different processors. For example, in an aspect, the one or more processors 1212 may include any one or any combination of a modem processor, or an applications processor, or a baseband processor, or a digital signal processor, or a transmit processor, or a receiver processor, or a transceiver processor associated with transceiver 1202. In other aspects, some of the features of the one or more processors 1212 and/or the modem 143 associated with the NAS component 142 may be performed by transceiver 1202. In some further aspects, some of the features of the one or more processors 1212 and/or the modem 143 and/or the AP component 145 associated with the EAP component 144 may be performed by transceiver 1202.

Also, memory 1216 may be configured to store data used herein and/or local versions of applications 1275 or the NAS component 142 and/or the EAP component 144 and/or one or more of their subcomponents being executed by at least one processor 1212. Memory 1216 can include any type of computer-readable medium usable by a computer or at least one processor 1212, such as random access memory (RAM), read only memory (ROM), tapes, magnetic discs, optical discs, volatile memory, non-volatile memory, and any combination thereof. In an aspect, for example, memory 1216 may be a non-transitory computer-readable storage medium that stores one or more computer-executable codes defining the NAS component 142 and/or the EAP component 144 and/or one or more of their subcomponents, and/or data associated therewith, when UE 104 is operating at least one processor 1212 to execute the NAS component 142 and/or the EAP component 144 and/or one or more of their subcomponents.

Transceiver 1202 may include at least one receiver 1206 and at least one transmitter 1208. Receiver 1206 may include hardware, firmware, and/or software code executable by a processor for receiving data, the code comprising instructions and being stored in a memory (e.g., computer-readable medium). Receiver 1206 may be, for example, a radio frequency (RF) receiver. In an aspect, receiver 1206 may receive signals transmitted by at least one base station 102 or 180. Additionally, receiver 1206 may process such received signals, and also may obtain measurements of the signals, such as, but not limited to, Ec/Io, SNR, RSRP, RSSI, etc. Transmitter 1208 may include hardware, firmware, and/or software code executable by a processor for transmitting data, the code comprising instructions and being stored in a memory (e.g., computer-readable medium). A suitable example of transmitter 1208 may including, but is not limited to, an RF transmitter.

Moreover, in an aspect, the UE 104 may include RF front end 1288, which may operate in communication with one or more antennas 1265 and transceiver 1202 for receiving and transmitting radio transmissions, for example, wireless communications transmitted by at least one base station 102 or 180 or wireless transmissions transmitted by the UE 104. RF front end 1288 may be connected to one or more antennas 1265 and can include one or more low-noise amplifiers (LNAs) 1290, one or more switches 1292, one or more power amplifiers (PAs) 1298, and one or more filters 1296 for transmitting and receiving RF signals.

In an aspect, LNA 1290 can amplify a received signal at a desired output level. In an aspect, each LNA 1290 may have a specified minimum and maximum gain values. In an aspect, RF front end 1288 may use one or more switches 1292 to select a particular LNA 1290 and its specified gain value based on a desired gain value for a particular application.

Further, for example, one or more PA(s) 1298 may be used by RF front end 1288 to amplify a signal for an RF output at a desired output power level. In an aspect, each PA 1298 may have specified minimum and maximum gain values. In an aspect, RF front end 1288 may use one or more switches 1292 to select a particular PA 1298 and its specified gain value based on a desired gain value for a particular application.

Also, for example, one or more filters 1296 can be used by RF front end 1288 to filter a received signal to obtain an input RF signal. Similarly, in an aspect, for example, a respective filter 1296 can be used to filter an output from a respective PA 1298 to produce an output signal for transmission. In an aspect, each filter 1296 can be connected to a specific LNA 1290 and/or PA 1298. In an aspect, RF front end 1288 can use one or more switches 1292 to select a transmit or receive path using a specified filter 1296, LNA 1290, and/or PA 1298, based on a configuration as specified by transceiver 1202 and/or processor 1212.

As such, transceiver 1202 may be configured to transmit and receive wireless signals through one or more antennas 1265 via RF front end 1288. In an aspect, transceiver may be tuned to operate at specified frequencies such that UE 104 can communicate with, for example, one or more base stations 102 or 180 or one or more cells associated with one or more base stations 102 or 180. In an aspect, for example, modem 143 can configure transceiver 1202 to operate at a specified frequency and power level based on the UE configuration of the UE 104 and the communication protocol used by modem 143.

In an aspect, modem 143 can be a multiband-multimode modem, which can process digital data and communicate with transceiver 1202 such that the digital data is sent and received using transceiver 1202. In an aspect, modem 143 can be multiband and be configured to support multiple frequency bands for a specific communications protocol. In an aspect, modem 143 can be multimode and be configured to support multiple operating networks and communications protocols. In an aspect, modem 143 can control one or more components of UE 104 (e.g., RF front end 1288, transceiver 1202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

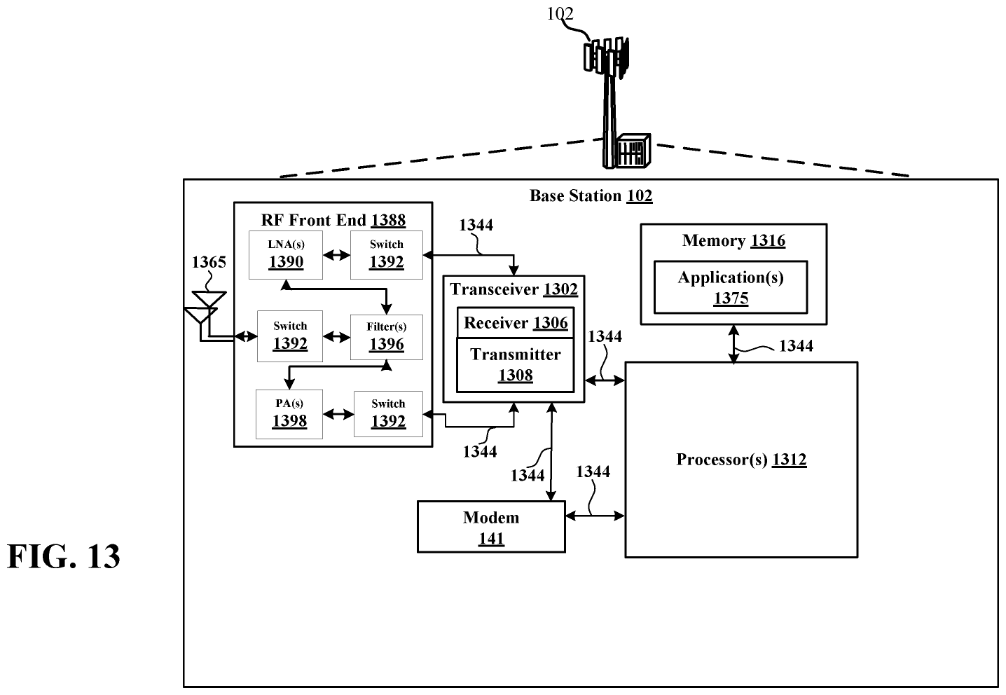

Referring to FIG. 13, one example of an implementation of base station 102 may include a variety of components, some of which have already been described above, but including components such as one or more processors 1312 and memory 1316 and transceiver 1302 in communication via one or more buses 1344, which may operate in conjunction with modem 141 to enable one or more of the functions described herein related to base station operations. The transceiver 1302, receiver 1306, transmitter 1308, one or more processors 1312, memory 1316, applications 1375, buses 1344, RF front end 1388, LNAs 1390, switches 1392, filters 1396, PAs 1398, and one or more antennas 1365 may be the same as or similar to the corresponding components of the UE 104, as described above, but configured or otherwise programmed for base station operations as opposed to UE operations.

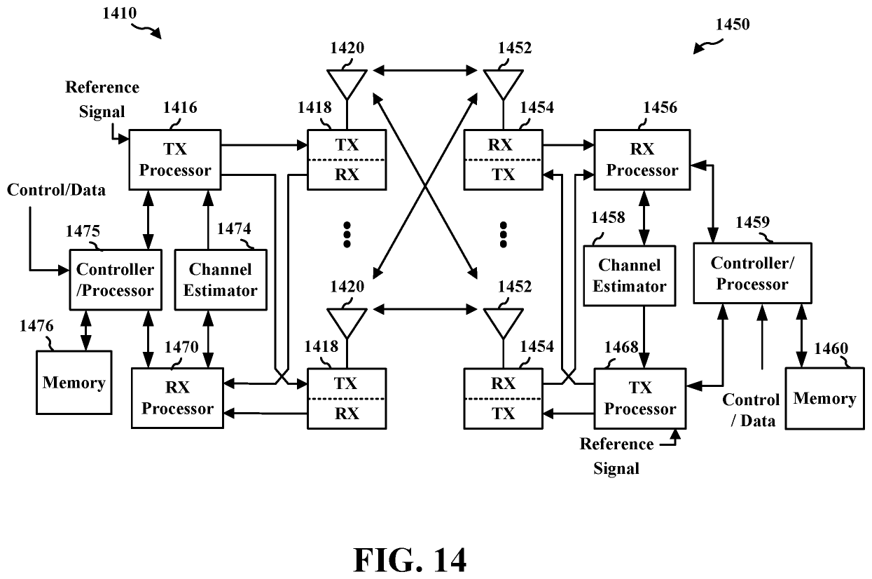

Referring to FIG. 14, an example of various components of a base station 1410 and a UE 1450 enable their communication exchange in an access network. In an aspect, one or more components of UE 1450 may implement applications 1275, modem 143, AP component 145, EAP component 144, and/or NAS component 142 described above with reference to FIG. 12. For example, in an aspect, one or more processors of UE 1450 (e.g., TX processor 1468, RX processor 1456, controller/processor 1459, etc.) can include modem 143 and/or can be part of modem 143 that uses one or more modem processors. In an aspect, the various functions related to AP component 145, EAP component 144, and/or NAS component 142 may be included in modem 143 and/or one or more processors of UE 1450 and, in an aspect, can be executed by a single processor, while in other aspects, different ones of the functions may be executed by a combination of two or more different processors. For example, in an aspect, one or more processors of UE 1450 may include any one or any combination of a modem processor, or a baseband processor, or a digital signal processor, or a transmit processor, or a receiver processor, or a transceiver processor associated with a transceiver. In other aspects, some of the features of modem 143, AP component 145, EAP component 144, and/or NAS component 142 may be performed by a transceiver 1454 of UE 1450. Also, memory 1460 of UE 1450 may be configured to store data used herein and/or local versions of applications 1275 or AP component 145, EAP component 144, and/or NAS component 142 and/or one or more of its subcomponents being executed by one or more processors of UE 1450. In an aspect, for example, memory 1460 may be a non-transitory computer-readable storage medium that stores one or more computer-executable codes defining AP component 145, EAP component 144, and/or NAS component 142 and/or one or more of its subcomponents, and/or data associated therewith, when UE 1450 is operating at least one processor to execute AP component 145, EAP component 144, and/or NAS component 142 and/or one or more of its subcomponents.

In the DL, IP packets from the EPC 160 may be provided to a controller/processor 1475. The controller/processor 1475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 1475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 1416 and the receive (RX) processor 1470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 1416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 1474 may be used to determine the coding and modulation scheme, as well as for spatial processing. The channel estimate may be derived from a reference signal and/or channel condition feedback transmitted by the UE 1450. Each spatial stream may then be provided to a different antenna 1420 via a separate transmitter 1418TX. Each transmitter 1418TX may modulate an RF carrier with a respective spatial stream for transmission.

At the UE 1450, each receiver 1454RX receives a signal through its respective antenna 1452. Each receiver 1454RX recovers information modulated onto an RF carrier and provides the information to the receive (RX) processor 1456. The TX processor 1468 and the RX processor 1456 implement layer 1 functionality associated with various signal processing functions. The RX processor 1456 may perform spatial processing on the information to recover any spatial streams destined for the UE 1450. If multiple spatial streams are destined for the UE 1450, they may be combined by the RX processor 1456 into a single OFDM symbol stream. The RX processor 1456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 1410. These soft decisions may be based on channel estimates computed by the channel estimator 1458. The soft decisions are then decoded and deinterleaved to recover the data and control signals that were originally transmitted by the base station 1410 on the physical channel. The data and control signals are then provided to the controller/processor 1459, which implements layer 3 and layer 2 functionality.

The controller/processor 1459 can be associated with a memory 1460 that stores program codes and data. The memory 1460 may be referred to as a computer-readable medium. In the UL, the controller/processor 1459 provides demultiplexing between transport and logical channels, packet reassembly, deciphering, header decompression, and control signal processing to recover IP packets from the EPC 160. The controller/processor 1459 is also responsible for error detection using an ACK and/or NACK protocol to support HARQ operations.

Similar to the functionality described in connection with the DL transmission by the base station 1410, the controller/processor 1459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 1458 from a reference signal or feedback transmitted by the base station 1410 may be used by the TX processor 1468 to select the appropriate coding and modulation schemes, and to facilitate spatial processing. The spatial streams generated by the TX processor 1468 may be provided to different antenna 1452 via separate transmitters 1454TX. Each transmitter 1454TX may modulate an RF carrier with a respective spatial stream for transmission.

The UL transmission is processed at the base station 1410 in a manner similar to that described in connection with the receiver function at the UE 1450. Each receiver 1418RX receives a signal through its respective antenna 1420. Each receiver 1418RX recovers information modulated onto an RF carrier and provides the information to a RX processor 1470.

The controller/processor 1475 can be associated with a memory 1476 that stores program codes and data. The memory 1476 may be referred to as a computer-readable medium. In the UL, the controller/processor 1475 provides demultiplexing between transport and logical channels, packet reassembly, deciphering, header decompression, control signal processing to recover IP packets from the UE 1450. IP packets from the controller/processor 1475 may be provided to the EPC 160. The controller/processor 1475 is also responsible for error detection using an ACK and/or NACK protocol to support HARQ operations.

The above detailed description in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method of wireless communications at a user equipment (UE), comprising:
initiating a security procedure for registering the UE at a first network, wherein the UE implements an extensible authentication protocol (EAP) component and a non-access stratum (NAS) component;
starting a NAS registration timer at the NAS component in response to initiating the security procedure, wherein an expiration of the NAS registration timer is configured to cause the NAS component to abort the security procedure;
determining an EAP failure in the security procedure;
determining whether the EAP failure is a recoverable type failure that is recoverable by retrying at least a portion of the security procedure or a not-recoverable type failure that is not recoverable by retrying any portion of the security procedure;
aborting the security procedure in response to the EAP failure being the not-recoverable type failure; and
suspending or re-starting the NAS registration timer in response to the EAP failure being the recoverable type failure.

2. The method of claim 1, wherein the first network is a fifth generation (5G) network in a standalone (SA) mode.

3. The method of claim 1, wherein the security procedure is an EAP method for third generation authentication and key agreement (EAP-AKA) or an improved EAP method for third generation authentication and key agreement (EAP-AKA′) authentication procedure over 3rd Generation Partnership Project (3GPP) fifth generation (5G) NAS signaling.

4. The method of claim 1, further comprising:
sending a first message from the EAP component to the NAS component to abort the security procedure in response to the EAP failure being the not-recoverable type failure; and
sending a second message from the EAP component to the NAS component to suspend or re-start the NAS registration timer in response to the EAP failure being the recoverable type failure.

5. The method of claim 4, wherein aborting the security procedure is performed by the NAS component in response to receiving the first message, wherein the method further comprises:
attempting to connect onto a second network different than the first network in response to the NAS component aborting the security procedure.

6. The method of claim 4, further comprising:
preventing, by the NAS component, subsequent registration attempts of the UE at the first network in response to receiving the first message.

7. The method of claim 4, wherein suspending or re-starting the NAS registration timer is performed by the NAS component in response to receiving the second message.

8. The method of claim 4, further comprising:
retrying at least the portion of the security procedure by the EAP component in response to sending the second message.

9. The method of claim 1, wherein determining whether the EAP failure is the recoverable type failure or the not-recoverable type failure further comprises determining that the EAP failure is an authentication key and agreement (AKA) sync failure, wherein the AKA sync failure is the recoverable type failure.

10. The method of claim 1, wherein determining whether the EAP failure is the recoverable type failure or the not recoverable type failure further comprises determining that the EAP failure is an authentication failure, wherein the authentication failure is the not-recoverable type failure.

11. The method of claim 1, wherein the UE comprises a cellular modem and an applications processor.

12. The method of claim 11, wherein the NAS component is implemented in the cellular modem, wherein the EAP component is implemented as an EAP library in the applications processor, wherein the EAP library and the NAS component communicate via at least one EAP application programming interface (API).

13. The method of claim 11, wherein the NAS component and the EAP component are implemented in the cellular modem, wherein the EAP component implements an additional layer accessible by the NAS component, wherein the EAP component and the NAS component communicate via the additional layer.

14. The method of claim 1, wherein the NAS component is configured according to 3rd Generation Partnership Project (3GPP) technical specification (TS) 24.501.

15. The method of claim 1, wherein the EAP component is configured according to internet engineering task force (IETF) request for comments (RFC) 3748.

16. A user equipment (UE), comprising:
a memory; and
at least one processor in communication with the memory, wherein the at least one processor is configured to:
initiate a security procedure for registering the UE at a first network, wherein the UE implements an extensible authentication protocol (EAP) component and a non-access stratum (NAS) component;
start a NAS registration timer at the NAS component in response to initiating the security procedure, wherein an expiration of the NAS registration timer is configured to cause the NAS component to abort the security procedure;
determine an EAP failure in the security procedure;
determine whether the EAP failure is a recoverable type failure that is recoverable by retrying at least a portion of the security procedure or a not-recoverable type failure that is not recoverable by retrying any portion of the security procedure;
abort the security procedure in response to the EAP failure being the not-recoverable type failure; and
suspend or re-start the NAS registration timer in response to the EAP failure being the recoverable type failure.

17. The UE of claim 16, wherein the first network is a fifth generation (5G) network in a standalone (SA) mode.

18. The UE of claim 16, wherein the security procedure is an EAP method for third generation authentication and key agreement (EAP-AKA) or an improved EAP method for third generation authentication and key agreement (EAP-AKA′) authentication procedure over 3rd Generation Partnership Project (3GPP) fifth generation (5G) NAS signaling.

19. The UE of claim 16, wherein the at least one processor is further configured to:
send a first message from the EAP component to the NAS component to abort the security procedure in response to the EAP failure being the not-recoverable type failure; and
send a second message from the EAP component to the NAS component to suspend or re-start the NAS registration timer in response to the EAP failure being the recoverable type failure.

20. The UE of claim 19,
wherein the at least one processor is configured to abort the security procedure by the NAS component in response to receiving the first message; and
wherein the at least one processor is further configured to attempt to connect onto a second network different than the first network in response to the NAS component aborting the security procedure.

21. The UE of claim 19, wherein the at least one processor is further configured to:
prevent, by the NAS component, subsequent registration attempts of the UE at the first network in response to receiving the first message.

22. The UE of claim 19, wherein the at least one processor is configured to suspend or re-start the NAS registration timer by the NAS component in response to receiving the second message.

23. The UE of claim 19, wherein the at least one processor is further configured to:
retry at least the portion of the security procedure by the EAP component in response to sending the second message.

24. The UE of claim 16, wherein the at least one processor is configured to determine whether the EAP failure is the recoverable type failure or the not-recoverable type failure further by determining that the EAP failure is an authentication key and agreement (AKA) sync failure, wherein the AKA sync failure is the recoverable type failure.

25. The UE of claim 16, wherein the at least one processor is configured to determine whether the EAP failure is the recoverable type failure or the not recoverable type failure further by determining that the EAP failure is an authentication failure, wherein the authentication failure is the not-recoverable type failure.

26. The UE of claim 16, wherein the UE comprises a cellular modem and an applications processor.

27. The UE of claim 26, wherein the NAS component is implemented in the cellular modem, wherein the EAP component is implemented as an EAP library in the applications processor, wherein the EAP library and the NAS component communicate via at least one EAP application programming interface (API).

28. The UE of claim 26, wherein the NAS component and the EAP component are implemented in the cellular modem, wherein the EAP component implements an additional layer accessible by the NAS component, wherein the EAP component and the NAS component communicate via the additional layer.

29. A user equipment (UE), comprising:
means for initiating a security procedure for registering the UE at a first network, wherein the UE implements an extensible authentication protocol (EAP) component and a non-access stratum (NAS) component;
means for starting a NAS registration timer at the NAS component in response to initiating the security procedure, wherein an expiration of the NAS registration timer is configured to cause the NAS component to abort the security procedure;
means for determining an EAP failure in the security procedure;
means for determining whether the EAP failure is a recoverable type failure that is recoverable by retrying at least a portion of the security procedure or a not-recoverable type failure that is not recoverable by retrying any portion of the security procedure;
means for aborting the security procedure in response to the EAP failure being the not-recoverable type failure; and
means for suspending or re-starting the NAS registration timer in response to the EAP failure being the recoverable type failure.

30. A non-transitory computer-readable medium storing computer code executable by a processor of a user equipment (UE), wherein the computer code, when executed by the processor, causes the processor to:
initiate a security procedure for registering the UE at a first network, wherein the UE implements an extensible authentication protocol (EAP) component and a non-access stratum (NAS) component;
start a NAS registration timer at the NAS component in response to initiating the security procedure, wherein an expiration of the NAS registration timer is configured to cause the NAS component to abort the security procedure;
determine an EAP failure in the security procedure;
determine whether the EAP failure is a recoverable type failure that is recoverable by retrying at least a portion of the security procedure or a not-recoverable type failure that is not recoverable by retrying any portion of the security procedure;
abort the security procedure in response to the EAP failure being the not-recoverable type failure; and
suspend or re-start the NAS registration timer in response to the EAP failure being the recoverable type failure.
